(19) United States
(12) Patent Application Publication
(10) Pub. No.: US 2021/0123727 A1
(43) Pub. Date: Apr. 29, 2021

(54) WHEEL ALIGNER

(71) Applicant: AUTEL INTELLIGENT TECHNOLOGY CORP., LTD., Shenzhen (CN)

(72) Inventors: Sanbao Shi, Shenzhen (CN); Huawu Yang, Shenzhen (CN); Yixiong Su, Shenzhen (CN)

(21) Appl. No.: 17/143,774

(22) Filed: Jan. 7, 2021

Related U.S. Application Data
(63) Continuation of application No. PCT/CN2019/111917, filed on Oct. 18, 2019.

(30) Foreign Application Priority Data
Oct. 19, 2018 (CN) 201811223694X

(51) Int. Cl. G01B 11/275

(52) U.S. Cl. CPC G01B 11/275; G01B 2210/26; G01B 2210/146

(57) ABSTRACT

Embodiments of the present invention relate to a wheel aligner. The wheel aligner includes at least one camera assembly including a shielding assembly and a camera device accommodated in the shielding assembly. The shielding assembly is configured to expose a lens of the camera device when the camera device is in operation and to shield the lens of the camera device when the camera device is not in operation. The wheel aligner according to the embodiments of the present invention can effectively prevent the lens of the camera device from being polluted by surroundings, while ensuring proper operation of the camera device.

This application is a continuation of International Patent Application No. PCT/CN2019/111917 filed on Oct. 18, 2019, which claims priority to Chinese Patent Application No. 201811223694.X filed on Oct. 19, 2018, both of which are incorporated by reference herein in their entireties.

### BACKGROUND

### Technical Field

The present application relates to the technical field of automobiles, and in particular, to a wheel aligner.

### Related Art

A wheel aligner is a precise measuring instrument for detecting wheel alignment parameters of an automobile, which obtains the wheel alignment parameters through a camera device, compares the wheel alignment parameters with original design parameters and instructs users to adjust the wheel alignment parameters to meet original design requirements, so that the vehicle runs stably, thus reducing tire wear.

During implementation of the present invention, the inventor finds at least the following problems in the related art. A lens of the camera device in the wheel aligner has high requirements for light and therefore cannot be shielded by transparent media such as glass. Long-time exposure to the surroundings causes the lens to be easily polluted by dust and oil stains, resulting in lens blur, which affects accuracy of four-wheel alignment.

### SUMMARY

In order to resolve the foregoing technical problems, embodiments of the present invention provide a wheel aligner, which can reduce pollution of the surroundings on a lens of a camera device in the wheel aligner.

The embodiments of the present invention adopt the following technical solutions to resolve the technical problem:

a wheel aligner, including: at least one camera assembly, where the camera assembly includes a shielding assembly and a camera device accommodated in the shielding assembly.

The shielding assembly is configured to expose a lens of the camera device when the camera device is in operation and to shield the lens of the camera device when the camera device is not in operation.

In some embodiments, the shielding assembly includes a housing, a shielding cover and a power device, where the camera device is accommodated in the housing and the housing is provided with an opening at a position corresponding to the lens of the camera device;

the shielding cover is disposed at the opening and the shielding cover is connected to the power device; and

the power device is configured to drag the shielding cover to move relative to the opening to reveal the opening, so that the lens of the camera device is exposed, when the camera device starts operating, and to drag the shielding cover to move relative to the opening to shield the opening, so that the shielding cover shields the lens of the camera device, when the camera device stops operating.

In some embodiments, the power device includes a motor unit and a transmission assembly that are connected to each other, where

the transmission assembly is configured to drive the shielding cover to move relative to the opening; and

the motor unit is configured to drive the transmission assembly to move, so that the shielding cover is driven to move relative to the opening through the transmission assembly to reveal the opening, when the camera device starts operating and

to drive the transmission assembly to move, so that the shielding cover is driven to move relative to the opening through the transmission assembly to shield the opening, when the camera device stops operating.

In some embodiments, the motor unit includes a motor, a motor driver and a controller, where the motor is electrically connected to the controller through the motor driver, where

the controller is configured to receive a control instruction and control the motor driver according to the control instruction, so that the motor driver drives the motor to rotate.

In some embodiments, the wheel aligner further includes a host, where the host is electrically connected to the controller, the host being also electrically connected to the camera device and

the host is configured to send a first control instruction to the camera device for controlling the camera device to start operating and send a first driving instruction to the controller for controlling the motor driver to drive the motor to rotate, so that the motor drives the shielding cover to move relative to the opening through the transmission assembly to reveal the opening and

to send a second control instruction to the camera device for controlling the camera device to stop operating and send a second driving instruction to the controller for controlling the motor driver to drive the motor to rotate, so that the motor drives the shielding cover to move relative to the opening through the transmission assembly to shield the opening.

In some embodiments, the shielding cover includes a first shielding body and a second shielding body that form a circle and the opening is circular, where a diameter of the circle formed by the first shielding body and the second shielding body is more than 1.2 times a diameter of the opening.

In some embodiments, the wheel aligner includes two camera assemblies.

In some embodiments, the wheel aligner further includes a base, a supporting rod and a connecting rod, where

the supporting rod is disposed on the base for supporting the connecting rod and the camera assemblies are disposed on both ends of the connecting rod respectively.

In some embodiments, the wheel aligner further includes a power adapter, where the power adapter is connected to the motor driver for supplying power to the motor driver.

In some embodiments, the host is connected to the controller through a USB interface.

According to the wheel aligner in the embodiments of the present invention, the camera device is disposed in the shielding assembly, the shielding assembly exposes the lens of the camera device when the camera device is in operation and the shielding assembly shields the lens of the camera device when the camera device is not in operation. The lens of the camera device can be effectively prevented from being polluted by the surroundings while ensuring proper operation of the camera device.

### BRIEF DESCRIPTION OF THE DRAWINGS

One or more embodiments are described by way of example with reference to the corresponding figures in the accompanying drawings, and the exemplary descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic structural diagram of an embodiment of a wheel aligner according to the present invention; and

FIG. 2 is a schematic diagram of electrical connection between some elements in a wheel aligner according to an embodiment of the present invention.

### DETAILED DESCRIPTION

For ease of understanding the present invention, the present invention is described in more detail below with reference to the accompanying drawings and specific embodiments. It should be noted that, when an element is described to be “fixed to” another element, the element may be directly fixed on the another element, or there may be one or more intermediate elements therebetween. When an element is described to be “connected to” another element, the element may be directly connected to the another element, or there may be one or more intermediate elements therebetween. The terms “vertical”, “horizontal”, “left”, “right”, “inner”, “outside”, and similar expressions used in this specification are merely used for an illustrative purpose.

Unless otherwise defined, meanings of all technical and scientific terms used in this specification are the same as those usually understood by a person skilled in art of the present invention. Terms used in the specification of the present invention are merely for description of the specific embodiments, and are not intended to limit the present invention. A term “and/or” used in this specification includes any or all combinations of one or more related listed items.

In addition, the technical features involved in the different embodiments of the present invention described below may be combined with each other if there is no conflict.

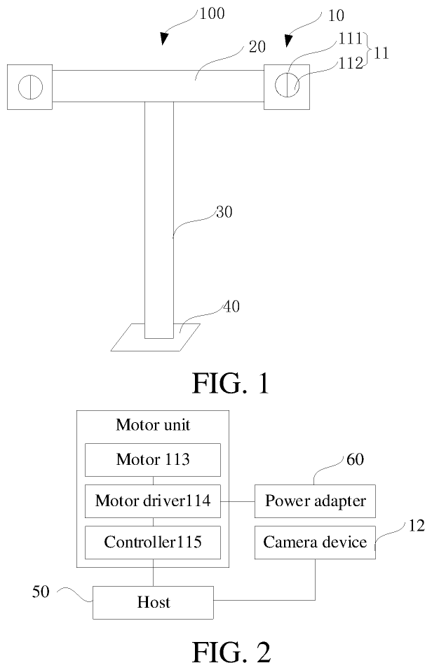

Referring to FIG. 1 and FIG. 2, a wheel aligner 100 provided in an embodiment of the present invention includes at least one camera assembly 10 (FIG. 1 shows an embodiment in which two camera assemblies 10 are included). The camera assembly 10 includes a shielding assembly 11 and a camera device 12 accommodated in the shielding assembly 11. The shielding assembly 11 is configured to expose a lens of the camera device 12 when the camera device 12 is in operation and shield the lens of the camera device 12 when the camera device 12 is in not in operation.

According to the wheel aligner 100 in the embodiments of the present invention, the camera device 12 is disposed in the shielding assembly 11. The shielding assembly 11 exposes the lens of the camera device 12 when the camera device 12 is in operation and the shielding assembly 11 shields the lens of the camera device 12 when the camera device 12 is not in operation. The lens of the camera device 12 can be effectively prevented from being polluted by the surroundings while ensuring proper operation of the camera device 12.

In some embodiments, referring to FIG. 1, the shielding assembly 11 includes a housing 111, a shielding cover 112 and a power device (not shown in the figure). The camera device 12 is accommodated in the housing 111. The housing 111 is provided with an opening at a position corresponding to the lens of the camera device 12. The shielding cover 112 is disposed at the opening. The shielding cover 112 is connected to the power device. The power device is configured to drag the shielding cover 112 to move relative to the opening, to reveal or shield the opening. A direction in which the power device drags the shielding cover 112 to move relative to the opening is not limited in the embodiments of the present application. For example, the power device drags the shielding cover 112 to rotate about an axis to toward or away from the opening, thus revealing or shielding the opening. Alternatively, the power device drags the shielding cover 112 to move parallel to the camera device 12, to reveal or shield the opening. When the camera device 12 starts operating, that is, changes from the non-operating state to the operating state, the power device drags the shielding cover 112 to move relative to the opening, to reveal the opening, so that the lens of the camera device 12 is exposed, thus ensuring that the camera device 12 captures an image properly. When the camera device 12 stops operating, that is, changes from the operating state to the non-operating state, the power device drags the shielding cover 112 to move relative to the opening, to shield the opening, so that the shielding cover 112 shields the lens of the camera device 12, thus preventing the lens of the camera device 12 in operation from being polluted by the surroundings.

Specifically, in some embodiments, the power device includes a motor unit and a transmission assembly that are connected to each other (not shown in the figure). The motor unit is configured to drive the transmission assembly to move and the transmission assembly is configured to drive the shielding cover 112 to move relative to the opening. The motor unit may adopt a structure shown in FIG. 2, which includes a motor 113, a motor driver 114 and a controller 115. The motor 113 is electrically connected to the controller 115 through the motor driver 114. The controller 115 is configured to receive a control instruction and control the motor driver 114 according to the control instruction, so that the motor driver 114 drives the motor 113 to rotate, thus driving the transmission assembly to move.

If the power device drags the shielding cover 112 to move parallel to the camera device 12, the transmission assembly may be a transmission assembly that is capable of converting rotational motion into linear motion in the prior art, for example, a synchronous wheel, a synchronous belt, or the like. The synchronous wheel is disposed on a rotating shaft of the motor 113. When the motor 113 rotates, the rotating shaft drives the synchronous wheel to rotate, so that the synchronous belt drives the transmission assembly to move, which converts rotational motion of the motor 113 into linear motion of the shielding cover 112. In this way, the shielding cover 112 can move relative to the opening under driving of the motor 113. Specifically, the shielding cover 112 may be controlled to reveal the opening and shield the opening respectively through control of forward rotation and reverse rotation of the motor. The motor driver 114 may be powered by an external power supply. Alternatively, as shown in FIG. 2, the motor driver 114 may be powered by a power adapter 60 connected to the motor driver 114.

Specifically, in some embodiments, referring to FIG. 1, the shielding cover 112 includes a first shielding body and a second shielding body that form a circle. The opening is also circular. In some embodiments, in order to enhance sealing, a size of the shielding cover 112 is greater than a size of the opening, that is, a diameter of the circle formed by the first shielding body and the second shielding body is greater than the diameter of the opening. For example, the diameter of the circle formed by the first shielding body and the second shielding body is 1.2 times the diameter of the opening.

In some embodiments of the wheel aligner 100, the wheel aligner 100 further includes a host 50. The host 50 is electrically connected to the controller 115. The host 50 is further electrically connected the camera device 12. To use the camera device 12, a user may send a first control instruction to the camera device 12 through the host 50 for controlling the camera device 12 to start operating. In addition, the host 50 sends a first driving instruction to the controller 115 for controlling the motor driver 114 to drive the motor 113 to rotate, so that the motor 113 drives the shielding cover 112 to move relative to the opening through the transmission assembly to reveal the opening. After use, the user may send a second control instruction to the camera device 12 through the host 50 for controlling the camera device 12 to stop operating. In addition, a second driving instruction is sent to the controller 115 for controlling the motor driver 114 to drive the motor 113 to rotate, so that the motor 113 drives the shielding cover 112 to move relative to the opening through the transmission assembly to shield the opening. Specifically, the host 50 may be connected to the controller 115 through a USB interface or other common interfaces. In some other embodiments, a wireless receiving module may also be disposed on the controller 115 and the camera device 12. A first control instruction, a second control instruction, a first driving instruction and a second driving instruction that are delivered by other electronic devices through wireless transmission are received through the wireless receiving module. Alternatively, a control key may be arranged in the wheel aligner. The user implements a function of the first driving instruction or the second driving instruction through the control key.

In some embodiments of the wheel aligner 100, referring to FIG. 1, the wheel aligner 100 further includes a base 40, a supporting rod 30 and a connecting rod 20. The connecting rod 20 is configured to be connected to the camera assembly 10 and the supporting rod 30 and the base 40 are configured to support the connecting rod 20 and the camera assembly 10. In some other embodiments, the camera assembly 10 may also be supported by a supporting table.

Finally, it should be noted that the foregoing embodiments are merely intended to describe the technical solutions of the present invention and are not to limit the present invention. Under the ideas of the present invention, the technical features in the foregoing embodiments or different embodiments may also be combined, the steps may be performed in any order, and many other changes of different aspects of the present invention also exists as described above, and these changes are not provided in detail for simplicity. Although the present invention is described in detail with reference to the foregoing embodiments, it should be appreciated by a person skilled in the art that, modifications may still be made to the technical solutions described in the foregoing embodiments, or equivalent replacements may be made to the part of the technical features; and the modifications or replacements do not cause essence of the corresponding technical solutions to depart from the scope of the technical solutions of the embodiments of the present invention.

What is claimed is:

1. A wheel aligner, comprising: at least one camera assembly, wherein the camera assembly comprises a shielding assembly and a camera device accommodated in the shielding assembly, wherein
the shielding assembly is configured to expose a lens of the camera device when the camera device is in operation and to shield the lens of the camera device when the camera device is not in operation.

2. The wheel aligner according to claim 1, wherein the shielding assembly comprises a housing, a shielding cover and a power device, wherein the camera device is accommodated in the housing and the housing is provided with an opening at a position corresponding to the lens of the camera device;
the shielding cover is disposed at the opening and the shielding cover is connected to the power device; and
the power device is configured to drag the shielding cover to move relative to the opening to reveal the opening, so that the lens of the camera device is exposed, when the camera device starts operating, and to drag the shielding cover to move relative to the opening to shield the opening, so that the shielding cover shields the lens of the camera device, when the camera device stops operating.

3. The wheel aligner according to claim 2, wherein the power device comprises a motor unit and a transmission assembly that are connected to each other, wherein
the transmission assembly is configured to drive the shielding cover to move relative to the opening; and
the motor unit is configured to drive the transmission assembly to move, so that the shielding cover is driven to move relative to the opening through the transmission assembly to reveal the opening, when the camera device starts operating and
to drive the transmission assembly to move, so that the shielding cover is driven to move relative to the opening through the transmission assembly to shield the opening, when the camera device stops operating.

4. The wheel aligner according to claim 3, wherein the motor unit comprises a motor, a motor driver and a controller, wherein the motor is electrically connected to the controller through the motor driver, wherein
the controller is configured to receive a control instruction and control the motor driver according to the control instruction, so that the motor driver drives the motor to rotate.

5. The wheel aligner according to claim 4, wherein the wheel aligner further comprises a host, wherein the host is electrically connected to the controller, the host is further electrically connected to the camera device and
the host is configured to send a first control instruction to the camera device for controlling the camera device to start operating and send a first driving instruction to the controller for controlling the motor driver to drive the motor to rotate, so that the motor drives the shielding cover to move relative to the opening through the transmission assembly to reveal the opening and
to send a second control instruction to the camera device for controlling the camera device to stop operating and send a second driving instruction to the controller for controlling the motor driver to drive the motor to rotate, so that the motor drives the shielding cover to move relative to the opening through the transmission assembly to shield the opening.

6. The wheel aligner according to claim 1, wherein the shielding cover comprises a first shielding body and a second shielding body that form a circle and the opening is circular, wherein a diameter of the circle formed by the first shielding body and the second shielding body is more than 1.2 times a diameter of the opening.

7. The wheel aligner according to claim 1, wherein the wheel aligner comprises two camera assemblies.

8. The wheel aligner according to claim 7, wherein the wheel aligner further comprises a base, a supporting rod and a connecting rod, wherein
the supporting rod is disposed on the base for supporting the connecting rod and the camera assemblies are disposed on both ends of the connecting rod respectively.

9. The wheel aligner according to claim 4, wherein the wheel aligner further comprises a power adapter, wherein the power adapter is connected to the motor driver for supplying power to the motor driver.

10. The wheel aligner according to claim 5, wherein the host is connected to the controller through a USB interface.
